(19) United States
(12) Patent Application Publication
(10) Pub. No.: US 2010/0288138 A1
(43) Pub. Date: Nov. 18, 2010

(54) Fry safe

(76) Inventors: Anthony S. Fiorino, Woodstock, MD (US); Mark V. Fiorino, Millers, MD (US)

Correspondence Address: RUTH EURE, 4795 EDISON AVENUE, BOULDER, CO, 80301, US

(21) Appl. No.: 12/800,220

(22) Filed: May 10, 2010

Related U.S. Application Data
(60) Provisional application No. 61/216,296, filed on May 15, 2009.

(51) Int. Cl. A47J 37/12

(52) U.S. Cl. 99/403

(57) ABSTRACT

The present invention provides a premium-quality stockpot for deep frying, each of which possesses a design improvement engineered to prevent or catch overflows and spills of cooking oil. The present invention is equipped with a pair of sturdy handles welded on either side of the pot rim. The distinguishing novel feature of the Fry Safe Cauldron design lies not within the pot but around its rim. The Fry Safe Cauldron comprises a continuous rimmed shelf, apron, or tray, around its circumference. The bottom of this rim or shelf would be approximately 6 centimeters below the rim of the pot, and would thus serve to capture and retain any cooking oil which should escape, overflow, or be spilled over the rim of the Cauldron.

### CLAIM OF PRIORITY

This patent application claims priority under 35 USC 119 (e) (1) from U.S. Provisional Patent Application Ser. No. 61/216,296 filed May 15, 2009, of common inventorship herewith entitled, “Fry Safe Cauldron.”

### FIELD OF THE INVENTION

The present invention pertains to the field of cooking vessels and more specifically to the field of cooking vessels for deep-frying of foods for human consumption.

### BACKGROUND OF THE INVENTION

The prior art has put forth several designs for improved cooking vessels for deep-frying foods. Among these are:

U.S. Pat. No. 5,746,117 to Chang describes a deep fryer which incorporates a fryer body and a removable basket. The removable basket comprises a handle which can be set in a horizontal relation to the fryer for use or in a vertical relation to the fryer for ease of storage.

U.S. Pat. No. 6,742,444 to Lai and Ho describes an electric cooking Apparatus comprising a tank, a deep fryer portion and control module which are all releasably engaged with one another. The tank has a bottom surface for supporting the food to be cooked.

US 2006/0272633 to Osias describes a safe turkey deep fryer which comprises an overflow sleeve connected to a drain basin by a flexible conduit.

None of these references describe the present invention.

### SUMMARY OF THE INVENTION

It is an object of the present invention to provide an apparatus for deep frying food which comprises a cauldron and lip on its circumference to prevent the splatter or spill of hot oil.

### BRIEF DESCRIPTION OF THE DRAWING

FIG. 1 is a perspective view of the present invention showing the cauldron and the lip on its circumference.

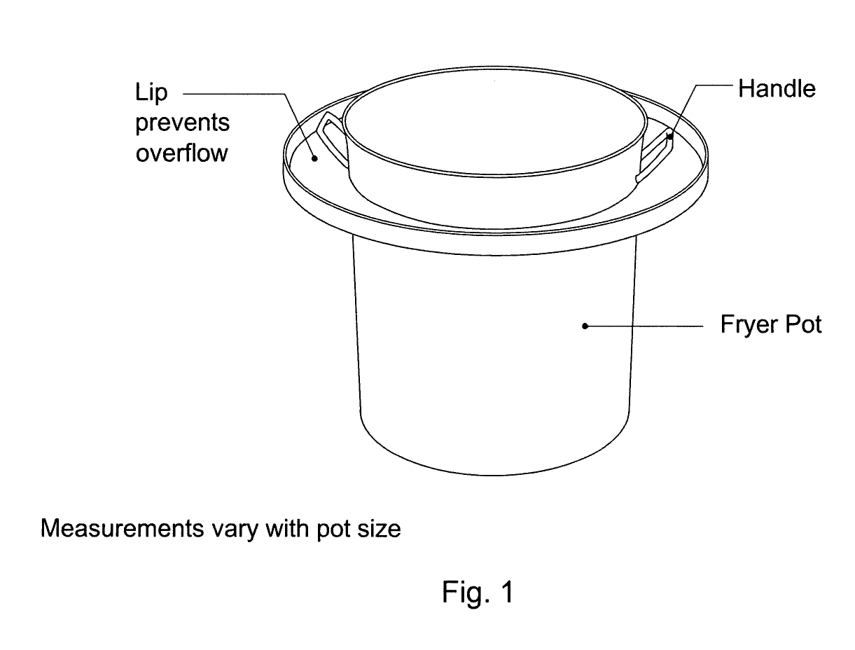

### DETAILED DESCRIPTION OF THE INVENTION

The present invention comprises an improvement in the design of the deep pot, kettle, vat, or cauldron used in deep frying. Deep frying has become extremely popular in recent years, whether for backyard seafood feasts or the Thanksgiving turkey. A kettle full of boiling oil is an accident waiting to happen, and many would-be cooks have learned to their sorrow what can happen when the oil overflows the kettle. The present invention prevents such mishaps and their attendant injuries.

Recognizing the dangers inherent in deep frying with traditional pots or kettles, the present invention, hereinafter referred to “The Fray Safe” or “The Fry Safe Cauldron” was developed. Simply stated, The Fry Safe Cauldron presents the consumer with a product line of premium-quality stockpots for deep frying, each of which possesses a design improvement engineered to prevent or catch overflows and spills of cooking oil. The basic Fry Safe Cauldron is offered in a variety of sizes, from a two-gallon (8-quart) pot, extending up to a 30-quart pot for deep-frying turkeys. The basic Fry Safe Cauldron measures approximately 35 centimeters in height by approximately 35 centimeters in inner diameter, and can be produced in steel or aluminum alloy by the Metal Stampings industry, Standard Industrial Code 3469, which manufactures metal household and commercial cookware.

The Fry Safe Cauldron is equipped with a pair of sturdy handles welded on either side of the pot rim. The distinguishing novel feature of the Fry Safe Cauldron design lies not within the pot but around its rim. The Fry Safe Cauldron comprises a continuous rimmed shelf, apron, or tray, around its circumference. The bottom of this rim or shelf would be approximately 6 centimeters below the rim of the pot, and would thus serve to capture and retain any cooking oil which should escape, overflow, or be spilled over the rim of the Cauldron. The rim extends from the circumference of the pot at least one inch, or more.

The Fry Safe Cauldron, a premium-quality, safety-enhanced kettle or stockpot for deep frying, presents a singular and profound advance over conventional deep-frying pots. The Fry Safe Cauldron, by incorporating a second, outer rim to catch any overflows or spills of cooking oil, would retain any such spilled or overflowed oil, and thereby prevent that oil from: 1) burning the cook, and 2) even worse, reaching the gas-ring or burner and starting a grease-fire. The Fry Safe Cauldron thus protects the deep-frying cook and crew from burns, and protects the cooking site from fires. The Fry Safe Cauldron design would be universal in application, and could be incorporated into the production of stockpots in virtually any size. As such, The Fry Safe Cauldron will become an essential part of the equipment of anyone who deep-fries—whether it's onion rings and chicken wings on the kitchen stove, or a deep-fried Christmas turkey outside on a gas-ring.

Although priced to compete with the conventional stockpots currently available on the market, The Fry Safe Cauldron represents a great advance in safety over prior art frying pots, while offering the durability and reliable cooking performance that professional chefs demand.

A pot or vat for deep frying, the peripherally extended rim of which would serve to contain any overflow of cooking oil, The Fry Safe Cauldron would prevent overflows and fires, and thus prove far safer in use than other pots used for deep frying. Fabricated of the highest-quality materials and built to provide a lifetime of service, the eminently affordable Fry Safe Cauldron should find a wide and extraordinarily receptive market among the consumer households and commercial eating establishments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vessel for deep frying comprising a rim around its periphery comprising steel or aluminum alloy and a pair of sturdy handles welded on opposite sides of the pot rim wherein the rim comprises a continuous rimmed shelf, apron, or tray, around its circumference wherein the bottom of the rim or shelf is approximately 6 centimeters below the rim of the pot, and serves to capture and retain any cooking oil which escapes, overflows, or is spilled over the rim of the vessel.

2. The vessel of claim 1 wherein the vessel is sized as a two-gallon (8-quart) pot.

3. The vessel of claim 1 wherein the vessel is sized as a 30-quart pot.

4. The vessel of claim 1 wherein the vessel measures approximately 35 centimeters in height by approximately 35 centimeters in inner diameter.

5. The vessel of claim 1 wherein the rim extends beyond the circumference of the vessel one or more inches.
